(19) United States
(12) Patent Application Publication
(10) Pub. No.: US 2009/0220304 A1
(43) Pub. Date: Sep. 3, 2009

(54) REMEDIATION WITH HYDROEXCAVATION AND SOLVENTS

(75) Inventors: Jim Ballew, Long Beach, CA (US); William Anderson, Huntington Beach, CA (US); Jong Soo Cho, Diamond Bar, CA (US); Mark Yeager, Taylor Lake Village, TX (US); Lee Daniel Starnes, Atlanta, GA (US)

Correspondence Address: DAVIS WRIGHT TREMAINE LLP/Los Angeles, 865 FIGUEROA STREET, SUITE 2400, LOS ANGELES, CA, 90017-2566, US

(73) Assignee: GGT WASTE, INC., Beverly Hills, CA (US)

(21) Appl. No.: 12/091,698

(22) PCT Filed: Oct. 24, 2006
(86) PCT No.: PCT/US2006/060186

§ 371 Date: Mar. 12, 2009

Related U.S. Application Data
(60) Provisional application No. 60/730,048, filed on Oct. 25, 2005.
(60) Provisional application No. 60/738,934, filed on Nov. 21, 2005.

(51) Int. Cl. B09C 1/00

(52) U.S. Cl. 405/128.1

(57) ABSTRACT

The present invention describes methods of contaminant removal and remediation utilizing hydroexcavation in Hydroexcavation of the soil combination with solvents and/or beneficial microbes, for primary scrubbing and high pressure mixing of the soil. Various embodiments of the present invention are useful for cleaning soil with contaminants, including but not limited to hydrocarbon based materials. The solvent used in conjunction with various embodiments of the present invention comprise a degreasing composition, which may comprise sodium silicate.

### FIELD OF INVENTION

This invention relates to remediation of soils with hydroexcavation, solvents and/or microbes.

### BACKGROUND

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

The past few decades have fostered the development of the environmental industry dedicated to minimizing the harm to the environment resulting from ordinary industrial activities. Both public and industry are increasingly aware of the harm caused by not taking steps to mitigate the effects of waste left in the environment. Simply not disposing the waste in an environmentally friendly manner and using containment is extremely expensive.

The nature and conditions under which hydrocarbons can collect and self-adhere are many and varied. Further complications are caused by other materials present in the environment where the hydrocarbons are collected. For example, in a refinery a hydrocarbon stream may be exposed to heavy metals which may accumulate along with the hydrocarbons. In oil fields, oil spillage around a well may collect with drilling mud in concrete cellars surrounding the well head. As can be seen, the presence of other materials can hamper disposal of the hydrocarbon waste for a number of reasons. Structurally the other materials can combine with the adhesive effect of the hydrocarbon to form a hard solid. Where the other materials predominate, the hydrocarbon can require bulk processing of a relatively larger mass of material to remove the same amount of hydrocarbon. In cases where other, relatively inert but structurally enhancing material is present, hydrocarbons contaminated with heavy metals can inhibit the remediation process due to the hazards involved in physically separating the contaminated hydrocarbons even before the step of decontaminating the hydrocarbon takes place.

One further problem in removing contaminated hydrocarbons is related to the use of solvents to dissolve and decrease the viscosity of the hydrocarbon portion of the material in order to facilitate the movement of the material; for example, through pipes and conduits by pumping. However, in order for hydrocarbon solvents to actively dissolve the contaminated hydrocarbons, they are often of low molecular weight and are therefore volatile. Working with volatile hydrocarbons represents an increase, rather than a decrease in hazards. Moreover, the result, even if the solvent dissolution works, is a volume of hazardous material that includes a volume of solvent which may be from about three to five times the volume of the original contaminated mass. Further, the hazardous material rather than being more concentrated to facilitate further treatment is now more dilute. Thus, an additional step must be performed to remove the solvent from both the hazardous material and the non-hazardous materials if any are present.

The removal of the solvent must be done in a way which will yield the return of the non-contaminated solvent. Such treatment usually involves a distillation tower. However, the introduction of a contaminated solid into a distillation tower will yield a bottoms product which is similarly difficult to remove, which will in effect restart the waste removal problem.

Soil washing scrubs soil to remove and separate the portion of the soil that is most polluted. This reduces the amount of soil that needs further cleaning. Soil washing alone may not be enough to clean polluted soil. Therefore, it is often used with other methods that further and complete the cleanup. Chemicals tend to stick or sorb to some types of soil more than others. For instance, chemicals sorb more to fine-grained soils (particle size smaller than about 100 mesh) such as silt and clay as compared to large/coarse-grained soils (particle size larger than about 100 mesh) such as sand and gravel. The silt and clay, in turn, tend to stick to sand and gravel. Soil washing helps separate the silt and clay from the large-grained, cleaner soils. Current methods of soil washing work best when the soil contains a much larger ratio of large-grained soils to fine-grained soils. Soil washing can clean up a variety of chemicals, such as fuels, metals, and pesticides that can sorb to soil.

Before using soil washing, soil dug from the polluted area is sifted to remove large objects, such as rocks and debris. The sifted soil is placed in a machine termed as a scrubbing unit. Water and sometimes detergents are added to the polluted soil in the scrubbing unit. The mixture of soil and water is passed through sieves, mixing blades, and water sprays. This washes and separates the silt and clay from the larger-grained soil. Some of the pollution may dissolve in the water or float to the top. The polluted wash water is removed and then cleaned at a treatment plant. The clean water can then be reused in the scrubbing unit or discharged.

The silt and clay, which contain most of the pollution, are tested for chemicals. Sometimes all of the pollution is removed in the wash water, but most often the silt and clay need further cleaning. The silt and clay may be washed again in the scrubbing unit or cleaned using another method such as bioremediation or thermal desorption. Another option is to dispose the polluted soils in a landfill.

The sand and gravel that settle to the bottom of the scrubbing unit are also tested for chemicals. If the sand and gravel are clean, they may be returned to the site of origin. If pollution is still present, they are washed again in the scrubbing unit. If necessary, another method is used to complete the cleaning process.

Soil washing is usually performed at the site. This avoids the risks involved with transporting polluted soil from the site to a cleaning facility. During digging and cleanup, air pollution control equipment may take care of dust and other potential air pollution problems. Chemicals are seldom released from the scrubbing unit to the air. However, the air may be tested at the site to ensure that chemicals are not released in harmful amounts. The soil is also subject to testing to ensure that it is clean before it is placed back on the site. When properly designed and operated, soil washing may be quite safe.

The greatest advantage of soil washing is that it reduces the amount of soil that needs further cleaning. This reduction may lower the cost of cleanup and the cost for disposing of polluted material. Soil washing can remove many types of pollution. However, current methods of soil washing are usually not very cost-effective on soils with a large amount of silt or clay. Further, current methods of soil washing are not optimal and may not remove all contaminants from soils with a large amount of silt or clay. Moreover, current methods may result in a large amount of waste water that requires further treatment or disposal as waste. Therefore, there is need in the art for a more effective and environmentally friendly method of soil washing.

### SUMMARY OF THE INVENTION

The following embodiments and aspects thereof are described and illustrated in conjunction with compositions and methods which are meant to be exemplary and illustrative, not limiting in scope.

The present invention describes methods of contaminant removal and remediation utilizing hydroexcavation in combination with solvents and/or beneficial microbes.

Some embodiments provide for methods for soil remediation, comprising adding a solvent to the soil; scrubbing the soil; creating a slurry; allowing the slurry to settle and separate into at least two layers; and removing at least one of the layers, wherein a bottom layer resulting from the settling and separation comprises remediated soil.

In one embodiment, the method further comprises removing the soil to be remediated by hydroexcavation. In another embodiment, the soil comprises coarse soil and fine soil and the method further comprises removing the coarse soil. In another embodiment, the method further comprises mixing the soil in a high pressure mixer with the solvent. In another embodiment, mixing the soil in the high pressure mixer may comprise continuously metering and mixing the soil with the solvent. In another embodiment, the method further comprises adding beneficial microbes to the soil and/or to the solvent.

In one embodiment, the soil contains a contaminant. In another embodiment, the contaminant may be live pathogens, arsenic, metals in tailings, methyl tertiary butyl ether (MTBE), hydrocarbon based material or combinations thereof. In another embodiment, the hydrocarbon based material may be crude oil, grease, gasoline, diesel fuel, fuel oil or combinations thereof.

In one embodiment, the solvent may comprise a degreasing composition. In another embodiment, the degreasing composition may comprise sodium silicate. In another embodiment, the degreasing composition may further comprise soy flour, lignin flour, and/or citrus pectin.

In another embodiment, scrubbing the soil may comprise passing a mixture of soil and water comprising the solvent through sieves, mixing blades, and/or water sprays. In another embodiment, the slurry may separate into at least three layers, a top layer comprising a hydrocarbon based material, a middle layer comprising the solvent and the bottom layer comprising the remediated soil, and the method may further comprise removing the top layer for further processing to reclaim usable oil from the hydrocarbon based material; and removing the middle layer for reuse or discarding.

An additional embodiment of the present invention provides for a method for soil remediation, comprising removing the soil comprising coarse soil and fine soil by hydroexcavation; adding a solvent to the soil; scrubbing the soil; removing the coarse soil; mixing the fine soil in a high pressure mixer thereby creating a slurry; allowing the slurry to settle and separate into at least three layers, wherein a top layer comprises a hydrocarbon based material, a middle layer comprises the solvent and a bottom layer resulting from the settling and separation comprises the remediated soil; and removing the bottom layer comprising the remediated soil. In one embodiment, the method may further comprise adding beneficial microbes to the soil and/or the solvent.

Other embodiments of the present invention comprise methods of remediation of materials with hydrocarbon based contaminants. In one embodiment, the method comprises removing the materials by hydroexcavation; adding a degreasing composition; creating a slurry; allowing the slurry to settle and separate into at least two layers; and extracting at least one of the at least two layers, wherein the at least one layer comprises remediated material. In one embodiment, the degreasing composition may comprise sodium silicate. In another embodiment, the degreasing composition may further comprise soy flour, lignin flour, and/or citrus pectin. In one embodiment, the degreasing composition may be added to water that is utilized by a hydroexcavator. In an alternate embodiment, the method may further comprise adding beneficial microbes.

Other features and advantages of the invention will become apparent from the following detailed description, taken in conjunction with the accompanying drawings, which illustrate, by way of example, various features of embodiments of the invention.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 depicts a flow chart of a method in accordance with an embodiment of the present invention.

FIG. 2 depicts a schematic diagram of a high pressure mixture that can be used with various embodiments of the present invention.

### DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs. Singleton et al., Dictionary of Microbiology and Molecular Biology 3^{rd} ed., J. Wiley & Sons (New York, N.Y. 2001) and March, Advanced Organic Chemistry Reactions, Mechanisms and Structure 5^{th} ed., J. Wiley & Sons (New York, N.Y. 2001) provide one skilled in the art with a general guide to many of the terms used in the present application.

One skilled in the art will recognize many methods and materials similar or equivalent to those described herein, which could be used in the practice of the present invention. Indeed, the present invention is in no way limited to the methods and materials described. For purposes of the present invention, the following terms are defined below.

“Antibiotics” as used herein refers to is a substance that kills or slows the growth of bacteria. Antibiotics can be derived from living organisms or they can be synthetic.

“Bioremediation” as used herein refers to the use of microbes or their enzymes to decrease the concentration of contaminants, such as hydrocarbon based compounds, in a sample in an environment. Examples of samples include, but are not limited to soil or water that contain contaminants. The sample can be remediated while present in the environment, or remediated before being introduced or reintroduced to the environment. The concentration of a contaminant may be decreased by techniques, including but not limited to, digesting, dissolving, breaking up, removing, decomposing or degrading the compound.

“Beneficial microbe” as used herein refers to microorganisms that have capabilities to impart beneficial properties to the environment. “Beneficial capabilities” include, but are not limited to the ability digest, dissolve, break up, remove, decompose, degrade, or kill contaminants. Examples of contaminants include but are not limited to live pathogens, arsenic, metals in tailings, methyl tertiary butyl ether (“MTBE”), waste material and hydrocarbon based material, such as oil. Examples of such microbes include, but are not limited to probiotics, bacteria, fungus, yeast and algae.

“Probiotics” as used herein refers to beneficial bacteria or yeast. Examples of probiotics include but are not limited to Bifidobacterium, Bifidobacterium bifidum, Bifidobacterium breve, Bifidobacterium infantis, Bifidobacterium longum, Lactobacillus, Lactobacillus acidophilus, Lactobacillus bulgaricus, Lactobacillus casei, Lactobacillus plantarum, Lactobacillus rhamnosus, Lactobacillus GG, Streptococcus thermophilus, Enterococcus and Saccharomyces boulardii.

“Degreasing composition” as used herein refers to organic or inorganic compositions that are able to dissolve, break up, remove, decompose, or degrade hydrocarbon based substances. The degreasing composition may exist as a solid, liquid or gas. In various embodiments, the degreasing composition may comprise one or more of the following: soy flour, lignin flour, citrus pectin and sodium silicate.

“Solvent” as used herein refers to any composition capable of dissolving or dispersing one or more other substances. The solvent used in various embodiments of the present invention may comprise one or more of the following: a degreasing composition, sodium silicate, a composition as described in U.S. Pat. No. 5,306,351, and a dispersion solution as described in U.S. Pat. No. 5,306,351.

“Treat,” “treating,” or “treatment” as used herein refer to a process where the object is to decrease the concentration of a contaminant, for example, by digesting, dissolving, breaking up, removing, decomposing, degrading, and killing the contaminant, even if the treatment is ultimately unsuccessful.

The present invention describes methods of contaminant removal and remediation utilizing hydroexcavation in combination with solvents and/or beneficial microbes.

Various embodiments of the present invention are useful for cleaning soil including but not limited to rock, gravel, sand, silt and clay with contaminants such as live pathogens, arsenic, metals in tailings, MTBE, waste material and hydrocarbon based material; for example, crude oil, grease, petroleum products such as gasoline, diesel fuel, and fuel oil. The contamination may be a result of, for example, oil spills, pipeline breaks, leaking fuel tanks, industrial operations, and the like.

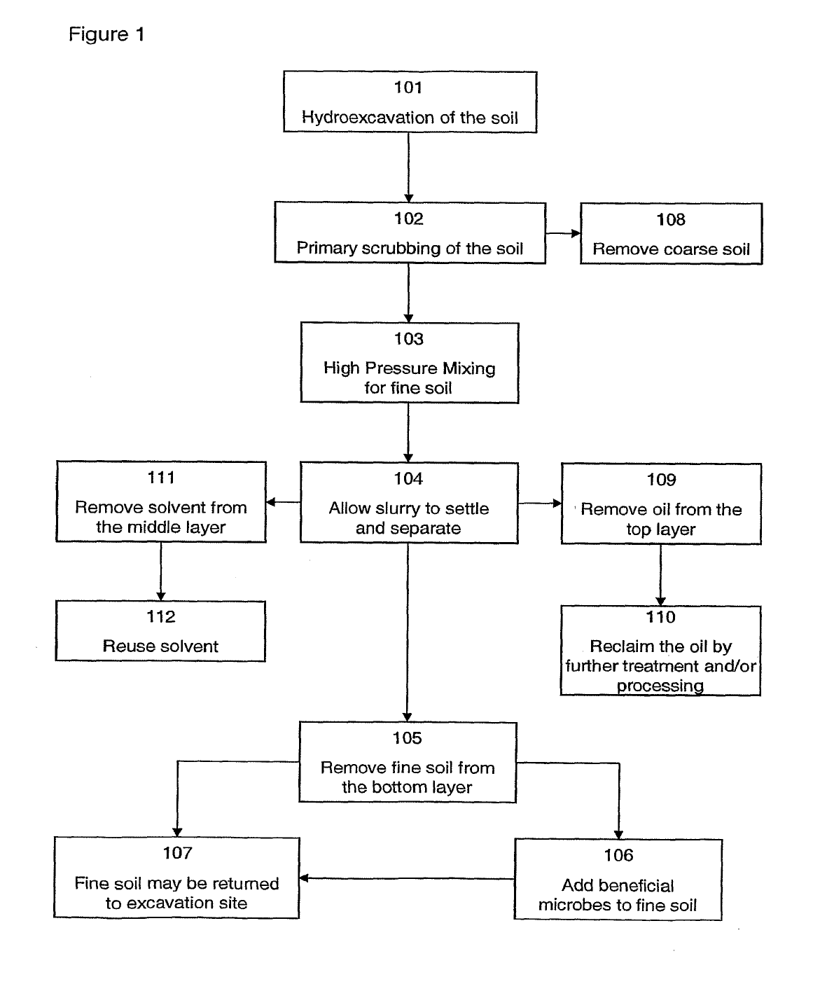

Embodiments of the present invention may comprise one or more of the following steps in any desirable order as depicted in FIG. 1. In step 101, hydroexcavation is used to remove the soil that contains contaminants. In step 102, the removed soil undergoes primary scrubbing. In step 108, coarser soil may be removed after primary scrubbing. In step 103, high pressure mixing is performed on the soil or on the finer soil thereby generating a slurry. In step 104, the slurry is allowed to settle and separate. In step 109, the oil may be removed from the top layer and be reclaimed in step 110 by further treatment and/or processing. In step 111, the solvent may be removed from the middle layer and may be reused in step 112. In step 105, the soil or the finer soil may be removed from the bottom layer and in step 106 beneficial microbes may be added to the soil or the finer soil and then returned to the excavation site in step 107. Alternatively, in step 107, the soil or the finer soil may be returned to the excavation site without the addition of beneficial microbes. In a further alternative embodiment, the soil or the finer soil may be used for any other purpose as will be readily appreciated by those of skill in the art; for example, for land farming.

The addition of solvent and/or microbes may be performed during one or more steps; for example, during hydroexcavation, primary scrubbing, and high pressure mixing.

The solvent used in conjunction with various embodiments of the present invention may be a solvent with degreasing capabilities. A solvent with degreasing capabilities may comprise a degreasing composition. An example of a degreasing composition can be found in U.S. Pat. No. 5,306,351, “Waste Oil Removal Composition and Method” which is incorporated by reference in its entirety as though fully set forth. Alternatively, the solvent may comprise sodium silicate. Other examples of solvents with degreasing capabilities will be readily identified and appreciated by those of skill in the art.

Degreasing compounds and technology (such as that described in U.S. Pat. No. 5,306,351) has found commercial uses. For example, certain state laws require that oil storage tanks be periodically emptied and inspected for leaks. A difficult aspect of this inspection process is the removal of accumulated crude oil sludge commonly referred to as “tank bottoms.” The semi-solid and solid sludge are often classified as hazardous waste materials, which must be removed and disposed of as such. The removal process is typically time, labor and transportation intensive, resulting in significant costs to the tank owners. The tank bottoms classified as hazardous waste must be trucked to an officially permitted “Class 1” hazardous waste disposal site where tipping fees are charged for emptying and cleaning the vacuum trucks. Handling and processing fees are charged by the operators of the disposal site. Furthermore, common clean-up technologies typically increase the total volume of the waste material by 100% to 300% in the form of condensed steam and/or cutter stock such as diesel fuel. In contrast, the degreasing technology described in U.S. Pat. No. 5,306,351 increases the total volume of the waste material by only 15% to 25%. Furthermore, waste oil sludge can be processed at the clean-up site to separate the reusable oil from rocks and granular solids captured during the drilling phase. The reclaimed crude oil thus becomes a valuable end product instead of a costly waste product.

Beneficial microbes, such as probiotics, bacteria, fungus, yeast and algae may be used to digest, dissolve, break up, remove, decompose, degrade and/or kill contaminants, including hydrocarbon based waste material, such as oil. WMI-2000, manufactured and distributed by WMI International, Inc. (Houston, Tex.), is an example of beneficial microbes that can be used. WMI-2000 is a bioremediation agent listed on the National Oil and Hazardous Substances Pollution Contingency Plan (NCP) Schedule. Other bioremediation agents appearing on the NCP Schedule may also be used. Additional examples of the use of beneficial microbes can be found in, for example, U.S. Pat. No. 6,884,301 (“Biological Cleaning System Comprising Microbes for Digesting Oils and/or Greases”), No. 6,787,034 (“Compositions for Removing Hydrocarbons and Halogenated Hydrocarbons from Contaminated Environments”), and No. 6,746,180 (“Remediation of Contaminates Including Low Bioavailability Hydrocarbons”). One skilled in the art will recognize further uses and sources of beneficial microbes to digest, dissolve, break up, remove, decompose, degrade and/or kill contaminants, including hydrocarbon based waste material, such as oil. In alternate embodiments of the present invention, any single beneficial microbe or a combination of beneficial microbes may be used.

Hydroexcavation with Solvents

Hydroexcavation is a method of digging with water, utilizing pressurized water and vacuuming processes to dig a hole or an area. Hydroexcavation reduces the risk of damaging existing underground infrastructures, such as fiber optic cables, sewer pipes, dangerous gas lines or process lines. Furthermore, hydroexcavation allows operators to dig in restricted areas where off-highway equipment cannot be utilized, such as clay, frozen ground, rocky terrain, and under concrete surfaces. During excavation, pressurized water (e.g., from about 2,000 to about 8,000 psi) may be used to penetrate the target area, such as soil, clay, frozen ground, rocky terrain, beneath concrete surfaces, oil tanks, oil drums, oil pits, and oil sumps. One skilled in the art will readily recognize the appropriate pressure for the water or solution used. In particular embodiments, certain pressures may be useful, for example, (1) for removal of sludge from a surface, pressures of up to 5000 psi, and in particular, pressures of about 2000 to about 4000 psi and pressures of about 3000 to about 4000 psi; and (2) for fluidizing oil pits or sumps, pressures of about 4000 to about 7000 psi, and about 4000 to about 8000 psi, respectively. The resulting slurry, such as water and soil mixture, is vacuumed up and may be dumped on or off site. If the slurry contains contaminants, it may also be relocated to an EPA approved landfill. As such, various embodiments of the present invention provides for remediation of the contaminated soil.

Further embodiments include fluidizing and excavating oil pits. Oil pits may contain solid and dehydrated crude oils. In one embodiment, the hydroexcavation equipment may inject water at about 20 to about 30 gallons per minute and pressures of about 4000 to about 7000 psi. This may be done at ambient temperatures. The resulting slurry may be vacuumed and transported to an oil recovery system.

Another embodiment includes fluidizing and excavating oil sumps. This process may be performed by specially equipped trucks. The specially equipped trucks may have extended components to reach out and fluidize the sump. The hydroexcavation equipment may inject the water at pressures of about 4000 to about 8000 psi at about 20% of the volume. This may be done at ambient temperature. The resulting slurry may be vacuumed and transported to an oil recovery system.

Further embodiments may utilize robots to perform any of the aforementioned operations. The robots may be hydraulically driven and may have the ability to move in any and all directions. The robots may have a fluidizing component to inject the inventive compositions, and a vacuuming component to pump out the resulting slurry.

In various applications, a solvent is added to the water utilized by the hydroexcavation equipment. The solvent may be a solvent with degreasing capabilities. A solvent with degreasing capabilities may comprise a degreasing composition. In one embodiment the solvent comprises a composition or dispersion solution as described in U.S. Pat. No. 5,306,351. In another embodiment, the solvent comprises sodium silicate. The use of a solvent for oil removal in conjunction with hydroexcavation may allow for simultaneous treatment and removal of the target areas or substances, such as soil, clay, frozen ground, rocky terrain, areas beneath concrete surfaces, oil tanks, oil drums, oil pits, and oil sumps. The hydroexcavation equipment places the solvent in contact with the target area, such as soil, which creates a slurry type mixture. The hydroexcavation equipment also vacuums slurry type mixture to remove it for separation of the components of the mixture on-site, in transit, or off-site. Degreasing technology may also be utilized to separate different components from a mixture that is vacuumed by the hydroexcavation equipment. In further applications of the process, the oil may be reclaimed and reused.

One dispersion solution is described by U.S. Pat. No. 5,306,351. Alternate dispersion solutions may be made from sodium silicate and water, in varying concentrations. Still other dispersion solutions can be made from a mixture of four components: soy flour, lignin flour, citrus pectin, and sodium silicate in varying combinations. Additional components such as non-ionic surfactants may be added. The dispersion solution may be injected at a high pressure, as needed, into the mass of material. Alternatively, the dispersion solution may be vigorously mixed, using a high pressure mixing process, with the contaminated material to be removed.

The dispersion solution is water based, yet causes the hydrocarbon to become fluid and retards self-adhesion. The retardation of self-adhesion is sufficient for enabling removal.

The vacuuming process may be performed simultaneously or after the solvent is placed in contact with the target area.

In an alternative embodiment, hydroexcavation equipment may be utilized to penetrate a target area, such as soil, clay, frozen ground, rocky terrain or an area beneath a concrete surface, with a solvent to thereby introduce and place in contact the solvent with the target area. In such embodiments, the vacuuming stage of hydroexcavation may need not be performed.

In other embodiments, the solvent can be added at any one or more stages of the hydroexcavation process, including prior to (i.e., by introducing the solvent in the hydroexcavation water), during (i.e., by introducing the solvent into the hydroexcavation water substantially as it is being introduced into a target area), and after (i.e., as a treatment step after soil or another target substrate is removed from the ground) the hydroexcavation process. Moreover, the solvent can be introduced at any or all of the aforementioned stages in hydroexcavation either in series or in parallel. In further embodiments, the solvent can be used on-site, in transit or at a facility. Any combination of these is contemplated as being within the scope of the present invention.

### Addition of Beneficial Microbes

In another embodiment, one or more types of beneficial microbes are added to the water utilized by the hydroexcavation equipment. Beneficial microbes are generally nonpathogenic, however, pathogenic beneficial microbes may also be used.

The use of microbes for oil removal in conjunction with hydroexcavation may allow for simultaneous treatment and removal of the target areas or substances, such as soil, clay, frozen ground, rocky terrain, areas beneath concrete surfaces, oil tanks, oil drums, oil pits, and oil sumps. The hydroexcavation equipment places the microbes for oil removal in contact with the target area, such as soil, which creates a slurry type mixture. The hydroexcavation equipment also vacuums slurry type mixture to remove it for separation of the components of the mixture on-site, in transit, or off-site.

In a further embodiment, a solvent and beneficial microbes are added to the water utilized by the hydroexcavation equipment. In a particular embodiment, beneficial microbes are added to a dispersion solution for oil removal, as described in U.S. Pat. No. 5,306,351, which is in turn utilized by the hydroexcavation equipment.

In a further embodiment, an antibiotic may also be added to the water utilized by the hydroexcavation equipment.

The use of beneficial microbes and solvents in conjunction with hydroexcavation may allow for simultaneous treatment and removal of the target areas or substances, such as soil, clay, frozen ground, rocky terrain, areas beneath a concrete surface from the ground, oil tanks, oil drums, oil pits, and oil sumps. The hydroexcavation equipment places the beneficial microbes and solvent in contact with the target area, such as soil, which creates a slurry type mixture. The hydroexcavation equipment also vacuums the slurry type mixture to remove it for separation of the components of the mixture on-site, in transit, or off-site. The vacuuming process may be performed simultaneously or after beneficial microbes and solvent are placed in contact with the target area.

In an alternative embodiment, hydroexcavation equipment may be utilized to penetrate a target area, such as soil, clay, frozen ground, rocky terrain or an area beneath a concrete surface, with water containing the beneficial microbes and the solvent to thereby introduce and place in contact the beneficial microbes and solvent with the target area. In such embodiments, the vacuuming stage of hydroexcavation need not be performed.

In other embodiments, the compositions (i.e., comprising beneficial microbes, a solvent, or both) can be added at any one or more stages of the hydroexcavation process, including prior to (i.e., by introducing the compositions in the hydroexcavation water), during (i.e., by introducing the compositions into the hydroexcavation water substantially as it is being introduced into a target area), and after (i.e., as a treatment step after soil or another target substrate is removed from the ground) the hydroexcavation process. Moreover, the compositions can be introduced at any or all of the aforementioned stages in hydroexcavation either in series or in parallel. In further embodiments, the compositions can be used on-site, in transit or at a facility. Any combination of these is contemplated as being within the scope of the present invention.

In a further embodiment, the soil is further treated by a biological method for final purification. Beneficial microbes may be added to further decontaminate the soil. Various embodiments of the present invention allow for quick removal of the contaminating oil, grease, or fuel, and may leave a small residue of the solvent, which itself may readily be biodegradable and may promote the growth of the beneficial microbes that degrade any residual traces of the contaminants.

Further, it is contemplated that this soil remediation method may be amenable to the addition of other chemicals, such as soaps, surfactants, and other materials having affinity for the contaminants for which removal is sought.

### Primary Scrubbing

In various embodiments, a solvent may be added before and/or during the primary scrubbing process. The primary scrubbing process may be performed by any method known in the art. For instance, a mixture of soil, water and/or solvent is passed through sieves, mixing blades, and water sprays. In one embodiment, the water spray may spray the solvent. The solvent may be a solvent with degreasing capabilities. A solvent with degreasing capabilities may comprise a degreasing composition. In one embodiment the solvent comprises a composition or dispersion solution as described in U.S. Pat. No. 5,306,351. In another embodiment, the solvent comprises sodium silicate.

In yet a further embodiment, beneficial microbes may be added before and/or during the primary scrubbing process.

### Separation of Contaminants and Soil

The removed material may be placed in a settling tank to allow the hydrocarbon material to undergo separation from the solvent, and re-adhesion if necessary.

In a settling tank, inorganic contaminants or materials such as soil, sand, dirt, silt, clay, etc., having a greater affinity for the solvent will fall out of solution. This action can be enhanced with the use of greater pressure at the removal site, and/or with the use of violent agitation before allowing it to settle. Due to the density differences, the hydrocarbon material will float atop the water soluble solvent, while the dirt and inorganic contaminants will fall to the bottom of the solvent. This permits the solvent to be redrawn from the middle of a settling tank and recycled through the system to be used to dislodge and transport more of the material to be removed.

### High Pressure Mixing Process

The high pressure mixing process may be performed by any method known in the art. For example, U.S. Pat. No. 3,468,322, herein incorporated by reference in its entirety as though fully set forth, provides a description of a high pressure mixing process and apparatus that may be used with various embodiments of the present invention.

The high pressure mixing process is continuously metering and rapidly mixing fine soil with a solvent. The solvent may be a solvent with degreasing capabilities. A solvent with degreasing capabilities may comprise a degreasing composition. In one embodiment the solvent comprises a composition or dispersion solution as described in U.S. Pat. No. 5,306,351. In another embodiment, the solvent comprises sodium silicate.

The soil with solvent forms a liquid slurry. The slurry then is metered into a flowing stream of solvent, usually on a proportionate basis. The solvent-slurry mixture is then forced through a turbulence inducer comprising a conduit in which there is at least one extended length of chain. Preferably, the number of chains should be sufficient to loosely fill the conduit. Good dispersion and dissolution rates may be achieved with longer chains.

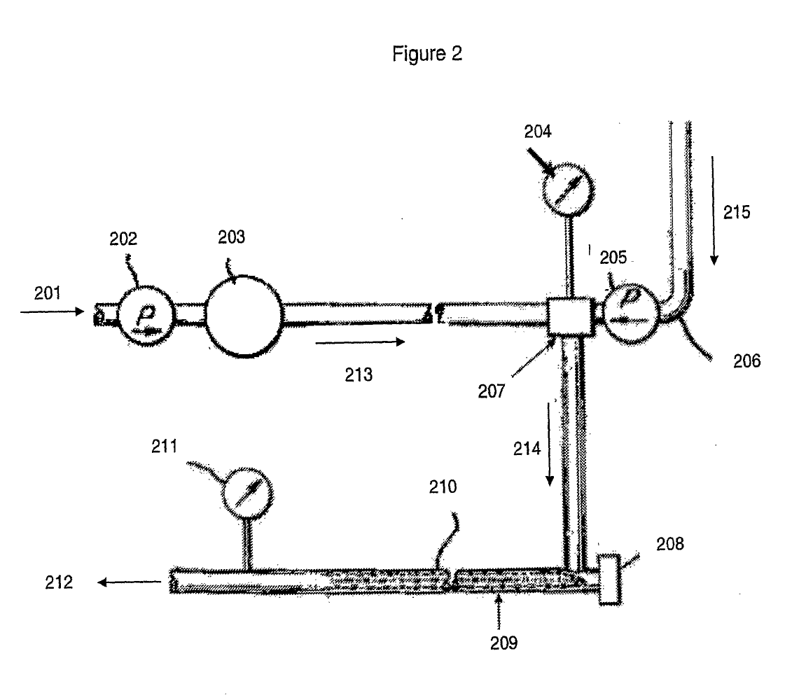

The process may be better understood by reference to FIG. 2, a flow diagram of the process and apparatus for implementing the same in accordance to an embodiment of the present invention. In FIG. 2, a mixing T 207 is supplied with solvent 201 by means of a centrifugal pump 202 through a line. The rate of flow is measured with a flow meter 203. A soil slurry 206 is pumped by means of a piston pump 205 through line into the mixing T 207. The mixture resulting from the confluence of solvent and soil slurry exits from the mixing T through the line into a turbulence inducer 210 comprising a conduit containing several lengths of chains 209. These lengths of chains are fastened at one end to a header cap 208 in the conduit upstream from the inlet for the mixture of solvent and slurry. Together they form a chain bed. On the discharge end of the conduit and on the mixing T are pressure gauges 211 and 204, respectively. Centrifugal pump 202 and piston pump 205 may be operated at relative rates to give a desired proportioning of soil to solvent. Arrows 213, 214 and 215 depict the flow direction of the substances. The slurry pumping rate will, of course, be dependent upon the concentration of the soil in the slurry. This may be any amount which can be conveniently fluidized in the non-solvent. Normally soil will not exceed about 40 percent by weight of the liquid slurry. The pressure and flow rate through the turbulence inducer is maintained at a level sufficient to yield effective dispersion and rapid dissolution. Effective pressure drops, between the upstream and downstream gauges, may vary according to the design of the turbulence inducer. With larger conduits, higher flow rates may be required to give a desired pressure drop. The number of chains and lengths within the turbulence inducer and the design or size of the chain links will also affect the pressure drop. Increasing the density of chain packing, i.e., increasing the number of chain lengths and chain links within each length, has a positive influence on the pressure drop per unit length of turbulence inducer. The total pressure drop may also be varied by increasing the length of the chain bed within the turbulence inducer. Pressure drops across the turbulence inducer of about 50 to 200 pounds per square inch will give good dispersion and solution rates.

Various modifications are possible with this apparatus. By adding chain filled conduits, more dispersion and mixing can be induced. In instances where more pressure drop is required, additional pumps can be added along with conduits.

The solvent-slurry mixture formed in the mixing T is subjected to uniform mixing along the tortuous flow path defined by the extended chain lengths within the turbulence inducer. On discharge from the turbulence inducer, the solvent-slurry system has undergone mixing adequate to produce a good dispersion of the solids without the use of severe or shearing agitation.

### EXAMPLES

The following examples are provided to better illustrate the claimed invention and are not to be interpreted as limiting the scope of the invention. To the extent that specific materials are mentioned, it is merely for purposes of illustration and is not intended to limit the invention. One skilled in the art may develop equivalent means or reactants without the exercise of inventive capacity and without departing from the scope of the invention.

### Example 1

### Hydroexcavation of Contaminated Soil

The hydroexcavation equipment utilizing a liquid is used to deliver the liquid into the contaminated soil at a high pressure. The liquid comprises any one or more of the following combinations: (1) a degreasing composition added to water, (2) the degreasing composition described in U.S. Pat. No. 5,306,351 added to water, (3) a dispersion solution for oil removal described U.S. Pat. No. 5,306,351, (4) beneficial microbes added to water, (5) beneficial microbes and a degreasing composition added to water, (6) beneficial microbes and the degreasing composition described in U.S. Pat. No. 5,306,351 added to water, (7) beneficial microbes and a dispersion solution for oil removal described U.S. Pat. No. 5,306,351, (8) sodium silicate added to water, and (9) antibiotics. The hydroexcavation equipment vacuums the contaminated slurry into a compartment for separation, such as a separation trailer. In the separation trailer, the slurry is separated into layers containing the contaminant, such as oil (i.e., top layer), the liquid (i.e., the middle layer), and the soil (i.e., the bottom layer). One skilled in the art will readily appreciate that the slurry can be separated into more than three layers. The contaminant, such as oil, is removed off of the top; the liquid may be reused; and the soil may be returned to its original environment. The separation process may be performed on-site, in transit, or off-site.

Alternatively, a composition comprising beneficial microbes, a degreasing composition, or both can be added at any one or more stages of the hydroexcavation process, including prior to (i.e., by introducing the composition in the hydroexcavation water), during (i.e., by introducing the composition into the hydroexcavation water substantially as it is being introduced into a target area), and after (i.e., as a treatment step after soil or another target substrate is removed from the ground) the hydroexcavation process. Moreover, the composition can be introduced at any or all of the aforementioned stages in hydroexcavation either in series or in parallel. In further embodiments, the compositions can be used on-site or at a facility. Any combination of these is contemplated as being within the scope of the present invention.

### Example 2

A dispersion solution of U.S. Pat. No. 5,306,351 is injected into the oil pit at pressures of about 4000 to about 7000 psi at ambient temperature. The resulting slurry is vacuumed and transported to an oil recovery system. In an application in fluidizing oil sumps, this process is performed by specially equipped trucks. The specially equipped trucks have extended components to reach out and fluidize the sump. The inventive compositions are injected at pressures of about 4000 to about 8000 psi at about 20% of the volume at ambient temperature. The resulting slurry is vacuumed and transported to an oil recovery system.

### Example 3

Sludge, drilling mud, dirt and/or debris mixture undergoes primary scrubbing with the use of a dispersion solution of U.S. Pat. No. 5,306,351. Coarse soil particles are removed. A dispersion solution of U.S. Pat. No. 5,306,351 and/or beneficial microbes is mixed with the fine soil particles in a high pressure mixture process. The mixture undergoes settling and separation in a separation tank. The oil from the top is removed and reclaimed for use. The dispersion solution is drawn out and may be reused. The fine soil particles may be returned to the place of origin. Beneficial microbes may be added to the fine soil particles prior, during transportation, or after the soil is returned to the place of origin.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. A method for soil remediation, comprising:
adding a solvent to the soil;
scrubbing the soil;
creating a slurry;
allowing the slurry to settle and separate into at least two layers; and
removing at least one of the layers,
wherein a bottom layer resulting from the settling and separation comprises remediated soil.

2. The method of claim 1, further comprising removing the soil to be remediated by hydroexcavation.

3. The method of claim 1, wherein the soil comprises coarse soil and fine soil and the method further comprises removing the coarse soil.

4. The method of claim 1, further comprising mixing the soil in a high pressure mixer with the solvent.

5. The method of claim 4, wherein mixing the soil in the high pressure mixer comprises continuously metering and mixing the soil with the solvent.

6. The method of claim 1, further comprising adding beneficial microbes to the soil and/or to the solvent.

7. The method of claim 1, wherein the soil contains a contaminant.

8. The method of claim 7, wherein the contaminant is selected from the group consisting of live pathogens, arsenic, metals in tailings, methyl tertiary butyl ether (MTBE), hydrocarbon based material and combinations thereof.

9. The method of claim 8, wherein the hydrocarbon based material is selected from the group consisting of crude oil, grease, gasoline, diesel fuel, fuel oil and combinations thereof.

10. The method of claim 1, wherein the solvent comprises a degreasing composition.

11. The method of claim 10, wherein the degreasing composition comprises sodium silicate.

12. The method of claim 11, wherein the degreasing composition further comprises soy flour, lignin flour, and/or citrus pectin.

13. The method of claim 1, wherein scrubbing the soil comprises passing a mixture of soil and water comprising the solvent through sieves, mixing blades, and/or water sprays.

14. The method of claim 1, wherein the slurry separates into at least three layers, a top layer comprising a hydrocarbon based material, a middle layer comprising the solvent and the bottom layer comprising the remediated soil, and the method further comprises:
removing the top layer for further processing to reclaim usable oil from the hydrocarbon based material; and
removing the middle layer for reuse or discarding.

15. A method of remediation of materials with hydrocarbon based contaminants, comprising:
removing the materials by hydroexcavation;
adding a degreasing composition;
creating a slurry;
allowing the slurry to settle and separate into at least two layers; and
extracting at least one of the at least two layers,
wherein at least one layer comprises remediated material.

16. The method of claim 15, wherein the degreasing composition comprises sodium silicate.

17. The method of claim 16, wherein the degreasing composition further comprises soy flour, lignin flour, and/or citrus pectin.

18. The method of claim 15, wherein the degreasing composition is added to water that is utilized by a hydroexcavator.

19. The method of claim 15, further comprising adding beneficial microbes.

20. A method for soil remediation, comprising:
removing the soil comprising coarse soil and fine soil by hydroexcavation;
adding a solvent to the soil;
scrubbing the soil;
removing the coarse soil;
mixing the fine soil in a high pressure mixer thereby creating a slurry;
allowing the slurry to settle and separate into at least three layers, wherein a top layer comprises a hydrocarbon based material, a middle layer comprises the solvent and a bottom layer resulting from the settling and separation comprises the remediated soil; and
removing the bottom layer comprising the remediated soil.

21. The method of claim 20, wherein the method further comprises adding beneficial microbes to the soil and/or the solvent.
